(19) United States
(12) Patent Application Publication
(10) Pub. No.: US 2006/0249350 A1
(43) Pub. Date: Nov. 9, 2006

(54) Delivering device for small parts

(76) Inventor: Frank Zimmerman, Lahnau (DE)

Correspondence Address: MILES & STOCKBRIDGE PC, 1751 PINNACLE DRIVE, SUITE 500, MCLEAN, VA, 22102-3833, US

(21) Appl. No.: 10/563,914

(22) PCT Filed: Jul. 10, 2004
(86) PCT No.: PCT/DE04/01511

§ 371 Date: Mar. 9, 2006

(30) Foreign Application Priority Data
Jul. 10, 2003 (DE) 10331409.1

(51) Int. Cl. B65G 41/00

(52) U.S. Cl. 198/300

(57) ABSTRACT

A device for feeding small parts to a conveying mechanism (9) is comprised of a reservoir (2) that is designed to accommodate a relatively large number of small parts and that has a bottom (3) with an elongated bottom recess (4), a slide (5) arranged in the bottom recess, which slide has an upper essentially horizontal feeder trough (7) for accommodating small parts, and an actuator (6) for achieving a relative motion between the reservoir (2) and the slide (5) such that the slide (5) can be moved relative to the reservoir (2) to a first position in which the bottom surface of the reservoir (2) and the feeder trough (7) are adjacent, and can be moved to a second position in which the feeder trough (7) is raised a specific distance above the bottom surface. The actuator can move the feeder trough (7) from the second position into an inclined third position in which the trough has an inclination to the horizontal that causes the feeding of the small parts.

The invention concerns a device for feeding small parts such as studs, pins, bushings, nuts, and the like to a conveying mechanism, comprising a reservoir that is designed to accommodate a relatively large number of small parts and that has a bottom with an elongated bottom recess and a bottom surface inclined downward toward the bottom recess, a slide arranged in the bottom recess, which slide has an upper essentially horizontal feeder trough for accommodating small parts, and an actuator for achieving a relative motion between the reservoir and the slide such that the slide can be moved relative to the reservoir to a first position in which the bottom surface of the reservoir and the feeder trough are adjacent, and can be moved to a second position in which the feeder trough is raised a specific distance above the bottom surface.

A device of the specified type is known from DE 694 14 520 T2. It serves to accept small parts from a relatively large supply and feed them prealigned to a conveying mechanism which feeds the small parts individually in a defined orientation to a process step. In the prior art device, a number of small parts remain in place in the feeder trough during the relative motion from the first position to the second position, during which time they are oriented by the shape of the feeder trough. In the second position, the small parts located in the feeder trough are then delivered to the attached conveying mechanism with the aid of a jet of air emerging from an air nozzle. However, specific geometries of the small parts and of the feeder trough are a prerequisite for feeding with the aid of a jet of air.

A feeder of similar construction is known from FR 2,484,377, in which the feeder trough in the feeder is angled downward such that in the second position of the slide the small parts slide from the feeder trough onto a conveyor belt due to their own weight. However, it must be seen as a disadvantage here that few small parts remain in place in the feeder trough when the slide moves from the first position to the second position, and that small parts can jam at the lower end of the feeder trough, thus hindering the sliding process.

The object of the invention is to design a device of the aforementioned type for feeding small parts that ensures trouble-free and reliable operation and is suitable for a variety of shapes and dimensions of small parts.

In order to attain this object, provision is made according to the invention for the feeder trough, whose orientation is essentially horizontal in the first and second positions, to be able to be moved by the actuator from the second position into an inclined third position in which it has an inclination that causes the feeding of the small parts.

In the inventive device, the orientation of the feeder trough is essentially horizontal during motion between the first and second positions so that numerous small parts can be accommodated and the parts do not jam. Once the second position has been reached, the feeder trough is brought into a third inclined position so that the small parts located in the feeder trough slide from it and are thereby fed to the conveyor device for further transport. There is no longer a risk that small parts will jam in this process, since the feeder trough is located above the small parts supply during the movement from the second position to the third position, and unobstructed transfer from the feeder trough to the conveyor is possible.

The inventive device is exceptionally quiet in operation and produces only minimal friction on the small parts to be fed. As a result, the frequently encountered surface coatings or easily deformed design elements of the components are handled especially gently, so that the device can also be used for feeding tasks involving very delicate parts. Moreover, the inventive device is suitable for a large variety of small parts with different shapes, weights and/or dimensions.

Moreover, an advantageous embodiment of the inventive device can consist in that the feeder trough is swivel-mounted to the slide and, in the second position of the slide, can be moved by the actuator into the inclined third position relative to the slide.

Furthermore, provision can be made in accordance with the invention that the actuator has a drive and a drive member for transmitting the drive motion to the slide and the feeder trough; in order to transmit the drive motion, the feeder trough is supported directly on the drive member and the slide is supported on the drive member through the intermediary of a spring, wherein the spring transmits the upward motion of the drive member to the slide and wherein the slide is prevented from moving by a stop when the drive member moves the feeder trough from the second position into the third position. This arrangement makes it possible to execute all movements of the inventive device with a single drive.

A preferred embodiment of the invention provides that a guide element, in which the drive member is mounted such that it is longitudinally movable, is attached to the slide. The spring can be supported on the guide element in this design.

Preferably the actuator has a crank mechanism whose crank is rotatably attached to one end of the drive member, wherein the guide element in which the drive member is guided in a longitudinally movable way is rotatably mounted on the slide.

In accordance with the invention, the slide is movably mounted in a linear guide on a stand, and in the second position said slide rests against a stop connected to the stand. In addition, the slide has a cuboid housing that encloses a hollow space into which the drive member projects and in which the guide for the drive member is arranged.

The invention is explained in detail below on the basis of an example embodiment, which is shown in the drawings. They show:

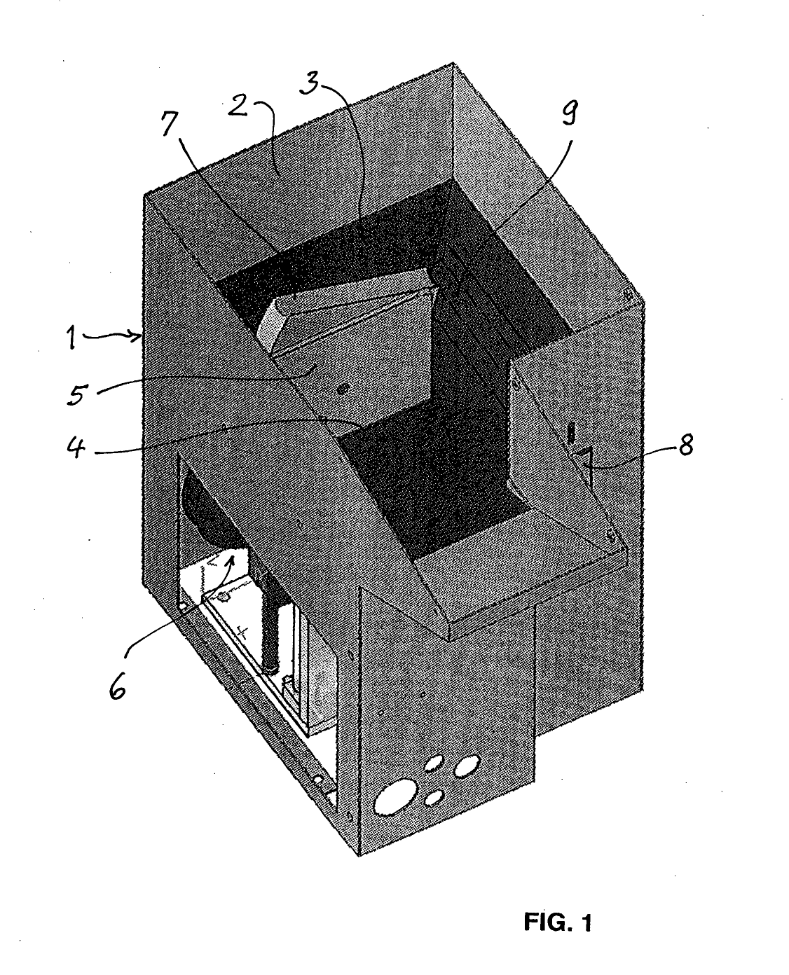

FIG. 1 a perspective view of the inventive device,

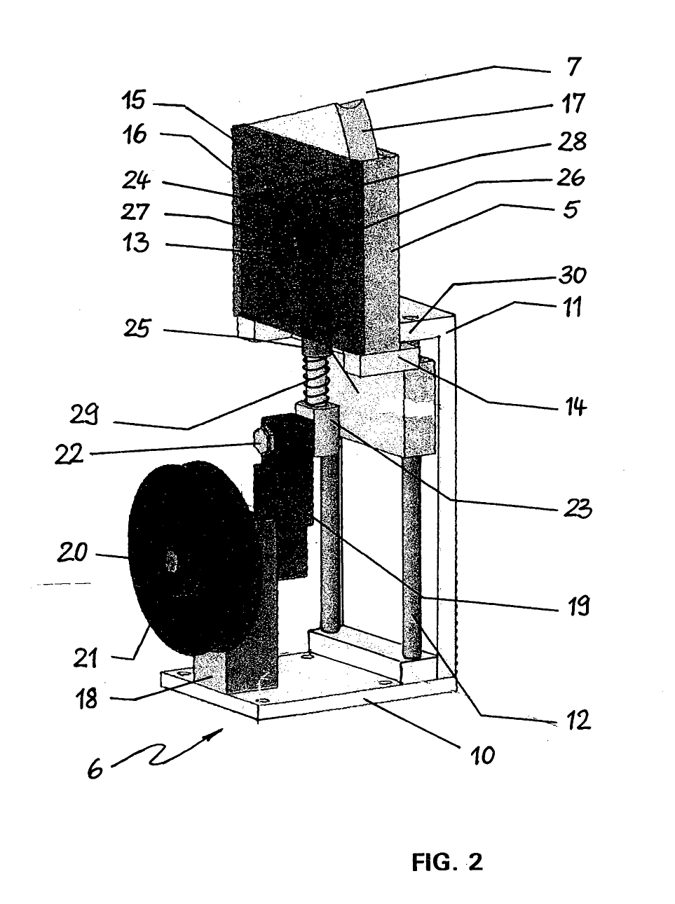

FIG. 2 a perspective view of the actuator from the device according FIG. 1,

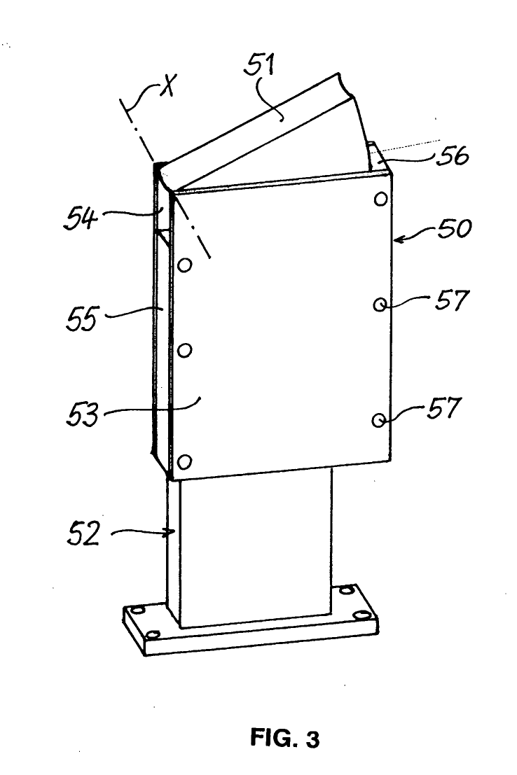

FIG. 3 a perspective view of another embodiment of the slide and the drive mechanism for a device according to FIG. 1,

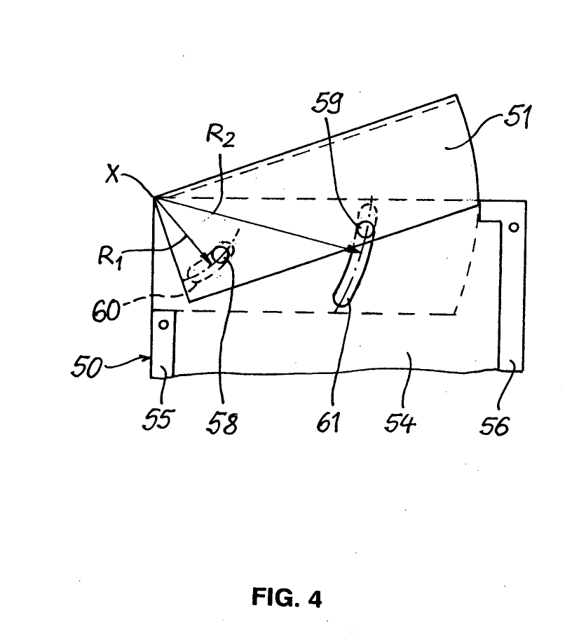

FIG. 4 a view of the support of the feeder trough of the slide according to FIG. 3, and

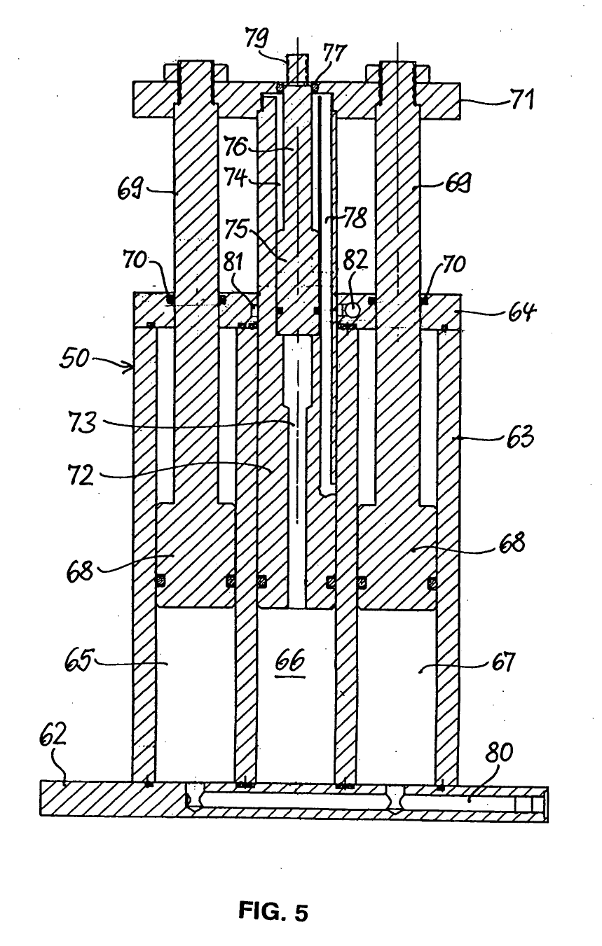

FIG. 5 a cross-section through the pneumatic drive mechanism of the slide from FIG. 3.

The device shown in FIG. 1 is composed of a box-like housing 1, which comprises a reservoir 2 that is open at the top to accommodate a fairly large number of small parts, such as studs, pins, bushings, nuts, and the like. The bottom 3 of the reservoir 2 has multiple bottom surfaces that are angled downward from the outside to the inside and terminate at a bottom recess 4 located at the lowest point approximately in the center of the reservoir 2. Located in the bottom recess 4 is a platelike slide 5 that can be moved vertically in the bottom recess 4 by means of an actuator 6 arranged beneath the bottom 3. Arranged on the upper, horizontally oriented end of the slide 5 is a feeder trough 7, which is movable between a horizontal position coincident with the top of the slide and a position shown in FIG. 1 that is inclined at an angle to the horizontal. A conveying mechanism 9 projects through a side opening 8 into the reservoir 2. In the position of the feeder trough 7 shown in FIG. 1, the trough is directly opposite the conveying mechanism 9 so that small parts located in the feeder trough 7 can be delivered to the conveying mechanism 9.

The design of the actuator 6 is visible in FIG. 2. A stand 11 with a linear guide composed of two parallel columns 12 is arranged on a base plate 10. A carriage 13 is supported on the columns 12 in a longitudinally movable manner, and constitutes a vertical guide for the slide 5, which is attached to the carriage 13 with the aid of a plate 14.

The slide 5 takes the form of a hollow, cuboid box that is open at the top and bottom. The feeder trough 7 is arranged in the top opening of the slide 5 and is swivel-mounted at the two longitudinal sides 15 of the slide 5 with the aid of two hinges 16. The support is designed such that the feeder trough 7 can move between the position shown in FIG. 2, in which its end 17 projects from the slide 5, and a position in which it is located inside the slide 5 and terminates flush with the top of the slide 5.

To move the slide 5 and the feeder trough 7, a crank 19 is rotatably mounted in a bearing block 18 arranged on the base plate 10; said crank is connected by a shaft 20 to a toothed pulley 21 in a rotationally fixed manner. The toothed pulley 21 can be made to rotate by a motor by means of a toothed belt which is not shown. A head bearing 23 of a drive member 24 that is designed as a cylindrical rod is rotatably supported by means of a pivot bearing at the free end of the crank 19 rotating about the shaft 20. The drive member 24 projects into the hollow space between the longitudinal sides 15 of the slide 5, and its end opposite the head bearing 23 contacts the underside of the feeder trough 7. Arranged on the drive member 24 is a guide bushing 25 that is longitudinally movable with respect to the drive member 24. At its upper end located within the slide 5, the guide bushing 25 is provided with a head bearing 26 that is rotatably supported at the two longitudinal sides 15 of the slide 5 by means of two bearing journals 27. A stop nut 28 arranged at the upper end of the drive member 24 limits the possible relative motion between the drive member 24 and the guide bushing 25. Arranged between the head bearing 23 and the guide bushing 25 is a spring 29 which acts to push apart the guide bushing 25 and the head bearing 23.

In the position of the actuator 6 shown in FIG. 2, the feeder trough 7 is located in its so-called third position in which it is opposite the conveying mechanism 9 and has an inclination such that small parts located in it slide from the feeder trough 7 due to their own weight and are thus fed to the conveying mechanism 9. This third position of the feeder trough 7 is also shown in FIG. 1. In this position, the underside of the feeder trough 7 rests on the upper end of the drive member 24. Its inclination is also determined by the position of the slide 5. The tensioned spring 29, whose spring force is transmitted through the guide bushing 25 to the slide 5, presses the plate 14 of said slide against a stop 30 formed by the stand 11 that limits the upward motion of the slide 5.

If new small parts are to be received by the feeder trough, the crank 19 is made to rotate, for example clockwise. This causes the drive member 24 to move downward toward the base plate 10, followed by the feeder trough 7. The spring 29 relaxes, but its spring force still suffices to keep the slide in the position defined by the stop 30. Once the drive member 24 is lowered far enough that the feeder trough 7 is located inside the slide 5, the stop nut 28 comes into contact with the head bearing 26. This transmits the downward motion of the drive member 24 to the guide bushing 25, with the force of the spring 29 now being supported directly by the stop nut 28 on the drive member 24. This has the result that the guide bushing 25 and the slide 5, which is articulated thereto by means of the bearing journals 27, are carried along by the downward motion of the drive member 24 and are likewise moved downward.

Once the crank 19 faces downward, the endpoint of the downward motion has been reached. In this first position, the slide 5 and the feeder trough 7 are lowered in the bottom recess 4 far enough that the upper edges of the bottom recess 4, the slide 5, and the feeder trough 7 are at approximately the same height. In this position of the feeder trough 7, the small parts located in the reservoir 2 can slide into the feeder trough 7 as a result of the inclination of the bottom surfaces, even if only a few parts remain, so that they can be carried along in the subsequent upward motion of the slide 5 and feeder trough 7. During the upward motion, the feeder trough 7 retains its horizontal position inside the slide 5 since the force of the spring 29 is sufficient to hold the guide bushing 25 in contact with the stop nut 28 against the forces and resistances to motion acting on the slide 5. This ensures that the small parts do not slide from the feeder trough 7 prematurely.

The second position of the feeder trough 7 is reached when the plate 14 of the slide 5 comes into contact with, and is stopped by, the stop 30. The feeder trough 7 is now at feeding height, but its orientation is still horizontal. The drive member 24 continues to travel upward so that the stop nut 28 lifts off the head bearing 26 and the feeder trough 7 is pivoted counterclockwise (FIG. 2) about the hinges 16 until it has reached the third position with the predefined inclination suitable for feeding the small parts.

The invention is not limited to the example embodiment described, but instead also includes other designs suitable for carrying out the teaching of the invention. Thus, for example, a pneumatically or hydraulically driven lifting cylinder may be provided for moving the drive member instead of the crank mechanism described. Direct drive of the crank by a motor is also conceivable. A DC motor, whose speed can be regulated by means of a control unit, is particularly suitable for use as a drive motor for the device described. In this way, the operating speed of the device, and thus the quantity of small parts fed, can be adjusted to the demand requirements in each case.

FIG. 3 shows another embodiment of a slide 50 with a feeder trough 51, which can be used in place of the slide 5 in the housing 1 in the device shown in FIG. 1. The slide 50 is arranged such that it can move vertically on a stand 52 containing pneumatic drive devices for moving the slide 50 and the feeder trough 51.

The slide 50 takes the form of a hollow, cuboid box that is open at the top and bottom. The box consists of two parallel, rectangular plates 53, 54, and strips 55, 56 arranged between the lateral edges of the plates 53, 54. The plates 53, 54 are rigidly attached to the strips 55, 56 by screws 57.

The feeder trough 51 is arranged in the top opening of the slide 50 between the plates 53, 54 and is supported on the plates 53, 54 in such a manner that it can pivot about an axis X that intersects its front edge and is perpendicular to the plates 53, 54. FIG. 4 shows the support of the feeder trough 51 in more detail. FIG. 4 shows the upper end of the slide 50 opened by the removal of the front plate 53. As a result, the rear plate 54 and also the region of the feeder trough 51 located between the plates can be seen. Attached to the feeder trough 51 in this region on both sides and at a distance from one another are two cylindrical pins 58, 59, which extend toward the plates and engage symmetrically arranged guide grooves 60, 61 on the inner sides of the plates 53, 54. The guide grooves 60, 61 have widths matched to the diameter of the pins 58, 59 and extend in each case along a circular arc whose center point lies on the axis X. The mean radii R₁ and R₂ of the guide grooves 60, 61 match the distance between the centers of the corresponding pins 58, 59 and the axis X.

Due to the pins and grooves described, the feeder trough 51 is supported in an interlocking fashion between the plates 53, 54 such that a force acting on it tangentially to the axis X forces it to execute a rotational motion about the axis X. The described concentric arrangement of the guide grooves 60, 61 has the advantage that the front edge of the feeder trough 51 does not change its location during its motion from the second position to the third position. This simplifies the arrangement of the conveying mechanism adjoining the feeder trough 51. The guide can be accommodated in a comparatively small area without impairing its ease of motion. Alternatively, however, only one arc-shaped groove may be provided in each of the plates 53, 54, with two pins arranged at a distance from one another engaging in each groove. Of course, the arrangement of grooves and pins can also be reversed by placing the guide grooves in the side surfaces of the feeder trough, with pins arranged on the plates engaging in said grooves.

FIG. 5 shows a cross-section through a stand 52 and the pneumatic drive mechanism located therein. The stand 52 consists of a base plate 62, a cylinder body 63, and a cover plate 64. Three parallel cylinder bores 65, 66, 67, which are closed at their bottom end by the base plate 62, are arranged in the cylinder body 63. A piston 68 with a piston rod 69 is arranged in each of the outer two cylinder bores 65, 67. The piston rods 69 of the two pistons 68 each extend through a bore in the cover plate 64 and are sealed with respect to this bore by means of seals 70. The free ends of the piston rods 69 are connected together by a carrier plate 71. The carrier plate 71 is used for mounting the slide 50. To this end, it has approximately the same width as the strips 55, 56. Thus, it can be arranged between the plates 53, 54 inside the slide 50 and can be rigidly attached to the plates 53, 54 by screws.

Arranged in the cylinder bore 66 is a cylindrical piston rod 72 that extends through the cover plate 64 and whose upper end is attached to the carrier plate 71. The piston rod 72 has a stepped through-bore 73 with an upper stepped section 74 in which is arranged a piston 75 with a piston rod 76. The piston rod 76 extends through a hole in the carrier plate 71 and is sealed therein by means of a seal 77. Parallel to the through-bore 73, the piston rod 72 has a bore 78 extending from the upper end of the piston rod 72 to a point located within the cover plate 64 in the upper end position of the piston rod 72. The carrier plate 71 forms a cap closing the upper ends of the through-bore 73 and the bore 78; this cap is separated a distance from the ends of the two bores such that the two are connected to one another within the cap. The end 79 of the piston rod 76 projecting beyond the carrier plate 71 is provided with an outside thread for fastening a pressure piece that acts together with the underside of the feeder trough 51 in order to transmit a motion of the piston rod 76 to the feeder trough 51.

The base plate 62 contains a connecting bore 80 for connection to a compressed air supply. The connecting bore 80 communicates with the lower ends of the cylinder bores 65, 67. A second connecting bore that communicates with the lower end of the cylinder bore 66 is located in the base plate outside the plane of the drawing, and is therefore not visible. The upper ends of the cylinder bores 65, 67 are connected to a common connecting bore (not shown) located in the cover plate 64. Also located in the cover plate 64 is an annular groove 81 that surrounds the piston rod 72 and communicates with a connecting bore 82.

To raise the carrier plate 71 and the slide 50 attached thereto, the cylinder bores 65, 67 are supplied with compressed air through the connecting bore 80. The upper ends of the cylinder bores 65, 67 communicate with the atmosphere for pressure relief. The pressure acting on the pistons 68 moves them upward until the piston rods 69 are fully extended and the pistons 68 rest against the cover plate 64. The slide 50 is now located in its second position, in which the feeder trough 51 is located completely inside the slide and is oriented horizontally. To move the feeder trough 51 into the third, inclined position, the cylinder bore 66 is also supplied with compressed air and the connecting bore 82, which in this position communicates with the bore 78 through the annular groove 81, is relieved of pressure. As a result, the piston 75 also travels upward and its piston rod 76 extending out of the carrier plate 71 pushes the feeder trough into the inclined, third position.

To retract the slide 50 and the feeder trough 51 into the lower end position, the cylinder bore 66 is first relieved of pressure and the bore 78 is connected to the compressed air supply through the annular groove 81 and the connecting bore 82. Once the piston 75 has reached the lower end position, the cylinder bores 65, 67 are then also relieved of pressure through the connecting bore 80 in the base plate 62, and are supplied with compressed air through the connecting bores in the base plate 64. As a result, the pistons 68, together with the carrier plate 71 and the piston rod 72, move to the lower end position corresponding to the position 1 of the slide 50, in which the carrier plate 71 rests against the cover plate 64.

Instead of the application of a pressure medium, the retraction of the slide 50 and the feeder trough 51 can be accomplished with the aid of springs, which are tensioned during raising. The springs can be arranged on the piston rods 69, 76 between the pistons 68, 75 and the cover plate 64 or the carrier plate, for example.

The described pneumatic drive mechanism has the advantage that it requires little space and thus can be integrated completely into the slide. The pivoting motion of the feeder trough can be controlled with a timing that is independent of the slide's stroke motion, which can be advantageous for adapting the conveyance to parts with different designs. The device is also characterized by simple construction, since the same parts are used for guiding and driving the slide.

1. Device for feeding small parts such as studs, pins, bushings, nuts, and the like to a conveying mechanism, comprising a reservoir that is designed to accommodate a relatively large number of small parts and that has a bottom with an elongated bottom recess and a bottom surface inclined downward toward the bottom recess, a slide arranged in the bottom recess, which slide has an upper feeder trough for accommodating small parts, and an actuator for achieving a relative motion between the reservoir and the slide such that the slide can be moved relative to the reservoir to a first position in which the bottom surface of the reservoir and the feeder trough are adjacent and the orientation of the feeder trough is essentially horizontal, and can be moved to a second position in which the feeder trough is raised a specific distance above the bottom surface while maintaining an essentially horizontal orientation, characterized in that the actuator can move the feeder trough (7) from the second position into an inclined third position in which the trough has an inclination to the horizontal that causes the feeding of the small parts.

2. Device according to claim 1, characterized in that the feeder trough (7) is swivel-mounted to the slide (5) and, in the second position of the slide, can be moved by the actuator into the inclined third position relative to the slide.

3. Device according to claim 1, characterized in that the actuator (6) has a drive and a drive member (24) for transmitting the drive motion to the slide (5) and to the feeder trough (7), which feeder trough (7) is supported directly on said drive member in order to transmit the drive motion.

4. Device according to claim 3, characterized in that the slide (5) is supported on the drive member (24) through the intermediary of a spring (29), which transmits the upward motion of the drive member (24) to the slide, and in that the slide (5) is prevented from moving when the drive member (24) moves the feeder trough (7) from the second position into the third position.

5. Device according to claim 1, characterized in that a guide element (25), in which the drive member (24) is mounted such that it is longitudinally movable, is attached to the slide (5).

6. Device according to claim 4, characterized in that the spring (29) is arranged between a head bearing of the drive member (24) and the guide element.

7. Device according to claim 1, characterized in that the actuator (6) has a crank mechanism whose crank (19) is rotatably attached to one end of the drive member (24), wherein the guide element (25) in which the drive member is guided in a longitudinally movable way is rotatably mounted on the slide (5).

8. Device according to claim 1, characterized in that the slide (5) is movably mounted in a linear guide on a stand (11).

9. Device according to claim 1, characterized in that the slide (5) has a cuboid housing that encloses a hollow space into which the drive member (24) projects and in which the guide for the drive member is arranged.

10. Device according to claim 1, characterized in that the slide (50) can be moved back and forth between the first and second positions by a piston/cylinder arrangement that can be supplied with a pressure medium, in particular compressed air.

11. Device according to claim 1, characterized in that the feeder trough (51) can be moved back and forth between the second and third positions by a piston/cylinder arrangement that can be supplied with a pressure medium, in particular compressed air.

12. Device according to claim 10, characterized in that the piston/cylinder arrangement for moving the slide (51) has two pistons (68) arranged in parallel cylinders (66, 67) with, extending out of the cylinders, piston rods (69) to whose ends the slide is attached.

13. Device according to claim 12, characterized in that a piston rod (72) connected to the slide (50) has a cylinder bore in which is arranged a piston (75) for moving the feeder trough (51).

14. Device according to claim 1, characterized in that the feeder trough (51) is supported on the slide (50) such that it can pivot about an axis (X) located on the front edge of the feeder trough.

15. Device according to claim 14, characterized in that the support of the feeder trough has guide grooves (60, 61) concentric to the axis (X) and pins (58, 59) that engage therein and are longitudinally movable therein.
